(19) United States
(12) Patent Application Publication
(10) Pub. No.: US 2010/0132658 A1
(43) Pub. Date: Jun. 3, 2010

(54) Star engine

(76) Inventor: Dam Thanh Ngo, Cambrigde (CA)

Correspondence Address: DAM THANH NGO, 3-30 CLOSE AVE, CAMBRIDGE, ON, N1R 2R6, CA

(21) Appl. No.: 12/315,064

(22) Filed: Nov. 28, 2008

(51) Int. Cl. F02B 53/00

(52) U.S. Cl. 123/242

(57) ABSTRACT

Star Engine is a four stroke internal combustion engine, which converts the eccentric motion of the center of the rotor directly to a rotary motion of a main shaft. This engine is formed by the principle a small circle rolling inside a larger one (FIG. 1). The star shape of both the rotor and stator are formed by the ratio between them (FIG. 2).

### OBJECTIVES OF THE INVENTION

A main object of the invention is to make the most of fuel energy by minimizing the loss of power during engine operation, therefore leaving more power for the output.

A further object of the invention is to reduce the use of material and maintain a light weight, the engine being compact in design.

A still further object of the invention is to minimize the loss of power by directly transferring power from the rotor to the output shaft.

A still further object of the invention is to reduce the friction force between the turning parts by shortening the traveling distance of the rotor, additionally reducing power consumption.

A still further object of the invention is to have a slower and smoother operation, allowing more time for the fuel to burn completely and creating higher fuel efficiency.

### BRIEF DESCRIPTION OF THE DRAWINGS

FIG. 1 is a sketch of five different positions of the small circle rolling inside a larger one.

FIG. 2 is a sketch showing the basics of the invention on a ratio of 5 and 6 between the two circles.

FIG. 3 is a perspective view of Star Engine showing four strokes going on inside the engine.

FIG. 4 is showing stroke one, the intake stroke.

FIG. 5 is showing stroke two, the compress stroke.

FIG. 6 is showing stroke three, the power stroke.

FIG. 7 is showing stroke four, the exhaust stroke.

FIG. 8 is a perspective view of Star Engine with a combination of assembly, cutaway, and exploded views showing inside and outside the engine.

FIG. 9 is an explode view showing a pair of stators and their related parts.

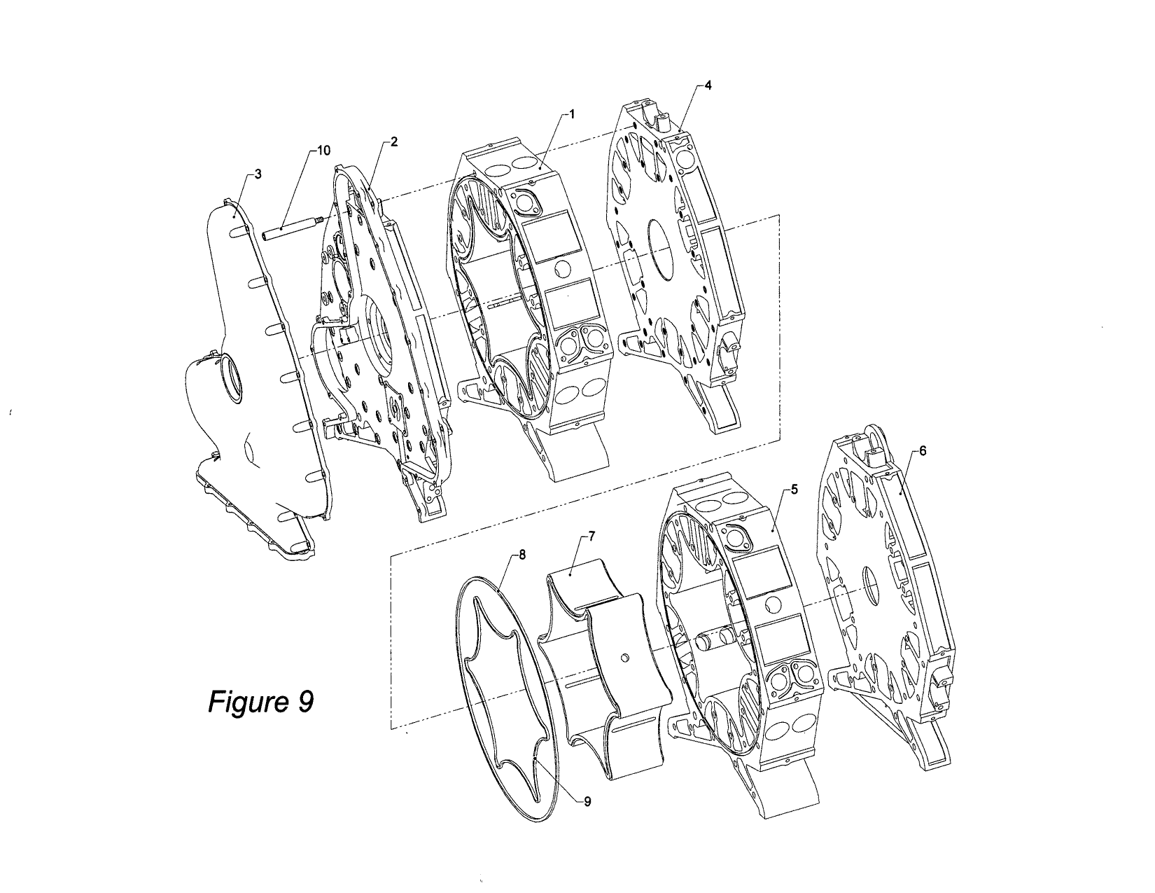

FIG. 10 is a perspective view of Star Engine with a combination of assembly, section, and exploded views showing the rotor, eccentric shaft, and a planetary gearset.

FIG. 11 is an exploded view of the front and rear planetary gearsets.

FIG. 12 is a perspective view of the eccentric shaft, camshafts, oil pump chain sprocket, cam chain sprockets, and a chain.

FIG. 13 is an exploded view of a camshaft and its related components, and an exploded view of a removable valve train.

FIG. 14 is an exploded view of the air intake and exhaust system components.

FIG. 15 is an exploded view of the valve covers and gaskets.

FIG. 16 is an exploded view of an oil pan and its related components.

FIG. 17 is an exploded view of lubrication components.

FIG. 18 is an exploded view of an alternator and its related components.

FIG. 19 is an exploded view of a water pump and its related components.

FIG. 20 is a perspective view of the front and the rear stator, and the firing order of the engine.

FIG. 21 is a graph of the paths of the points on the World Coordinate System and tables of some sample values.

FIG. 22 is a perspective view of Star Engine 431 showing a three-pointed star shaped rotor inside a four-pointed star shaped stator.

FIG. 23 is a perspective view of Star Engine 871 showing a seven-pointed star shaped rotor inside an eight-pointed star shaped stator.

FIG. 24 is an exploded view of a “True-Path” Star Engine 431 showing some basic parts.

FIG. 25 is an exploded view of a 431 star engine showing most of its parts.

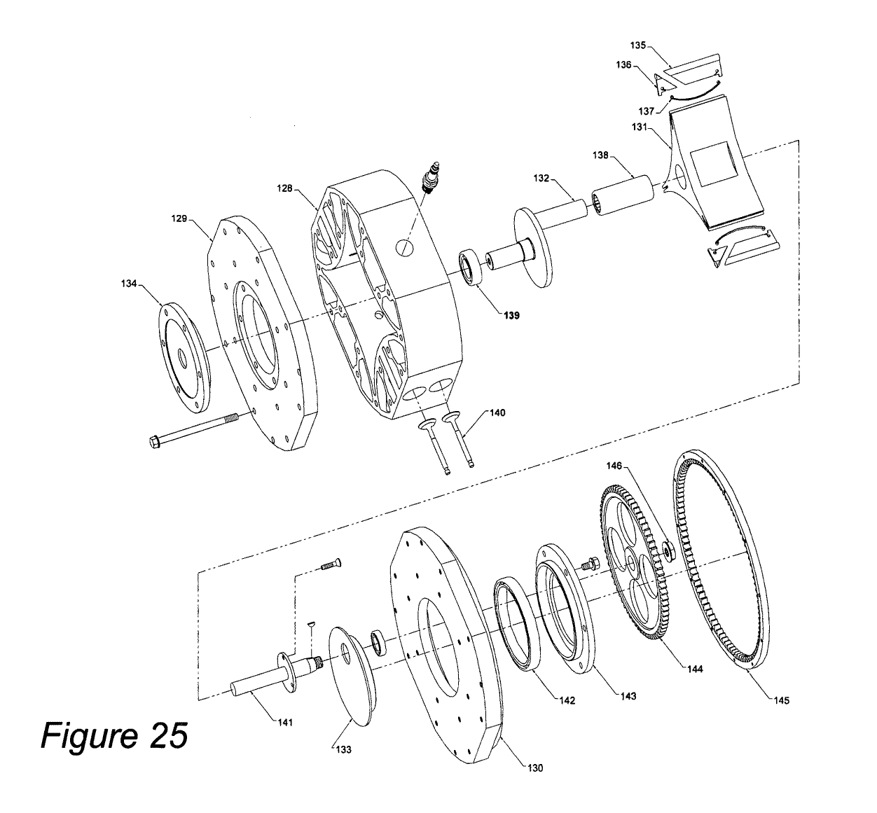

### DETAILED DESCRIPTION OF THE INVENTION

PART 1: The Concept and the Calculation
1. The Star Engine is based on the principle:
   WHEN A CIRCLE ROLLS INSIDE A LARGER ONE, ITS MOVEMENT IS DETERMINED BY THE RATIO BETWEEN THEM.
2. The movement of any point on the small circle is determined by the trigonometric equation:

r=cos θ+n cos α
Where r is the path of a point on the World Coordinate System, cos θ is the eccentric diameter of the eccentric shaft in degree (r=cos θ is equation of a circle), n is a distance other than 0 (values either being positive or negative) or the radius of the eccentric diameter of the central point, and cos a is the ratio of the difference of the two circles in size, also in degree. For example: the difference of the two circles of the Star Engine 651 is 5 to 1 in degree.

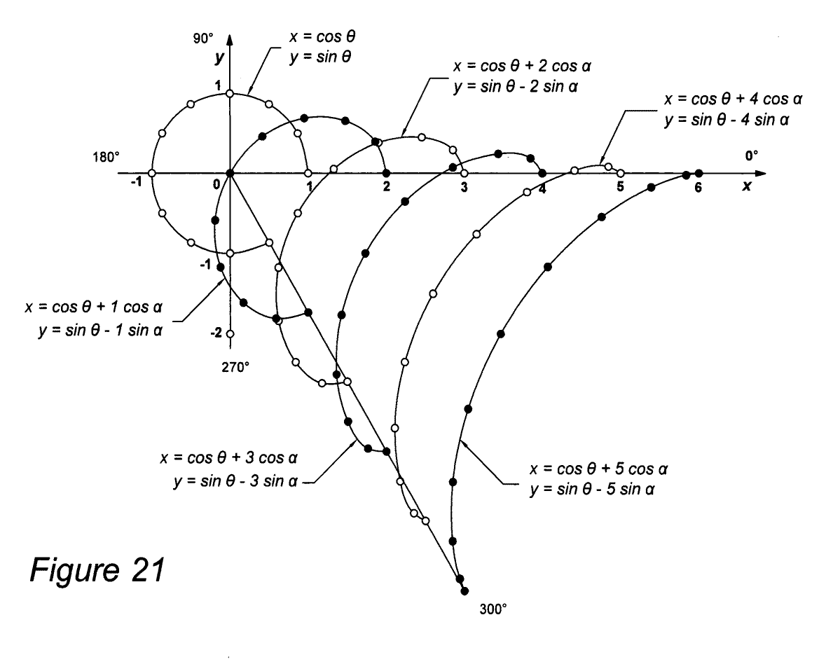

θ°=5 α°
When θ=30°, α=6°, and when θ=60°, α=12°, and so forth.
3. The position of x and y of any point on the World Coordinate System can be found by these equations (FIG. 21):

x=cos θ+n cos α

And, y=sin θ−n sin α
When n=1, x is determined by the equation x=cos θ+1 cos α, and y is determined by y=sin θ−1 sin a on the table below:

| | | | | | | | | | | | |
|---|---|---|---|---|---|---|---|---|---|---|---|
| θ | 0 | 30° | 60° | 90° | 120° | 150° | 180° | 210° | 240° | 270° | 300° |
| α | 0 | 6° | 12° | 18° | 24° | 30° | 36° | 42° | 48° | 54° | 60° |
| x | 2 | 1.8605 | 1.4781 | 0.951 | 0.4135 | 0 | −0.191 | −0.1229 | 0.1691 | 0.5878 | 1 |
| y | 0 | 0.3955 | 0.6581 | 0.6910 | 0.4593 | 0 | −0.5878 | −1.1691 | −1.6092 | −1.809 | −1.7321 |

When n=5, at a contacting point between the two circles, both values of x and y are determined by the equation x=cos θ+5 cos α, and y is determined by y=sin θ−5 sin a on the following table:

| | | | | | | | | | | | |
|---|---|---|---|---|---|---|---|---|---|---|---|
| θ | 0 | 30° | 60° | 90° | 120° | 150° | 180° | 210° | 240° | 270° | 300° |
| α | 0 | 6° | 12° | 18° | 24° | 30° | 36° | 42° | 48° | 54° | 60° |
| x | 6 | 5.8386 | 5.3907 | 4.7553 | 4.0677 | 3.4641 | 3.0451 | 2.8497 | 2.8457 | 2.9389 | 3 |
| y | 0 | −0.0226 | −0.1735 | −0.5451 | −1.1677 | −2 | −2.9389 | −3.8457 | −4.5817 | −5.0451 | −5.1962 |

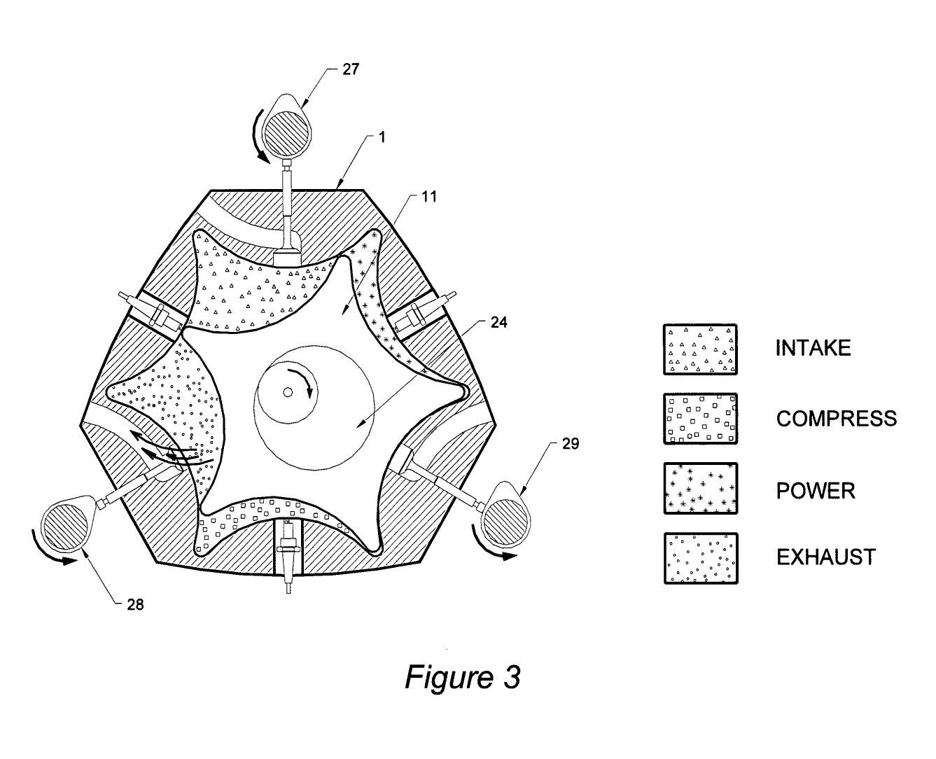

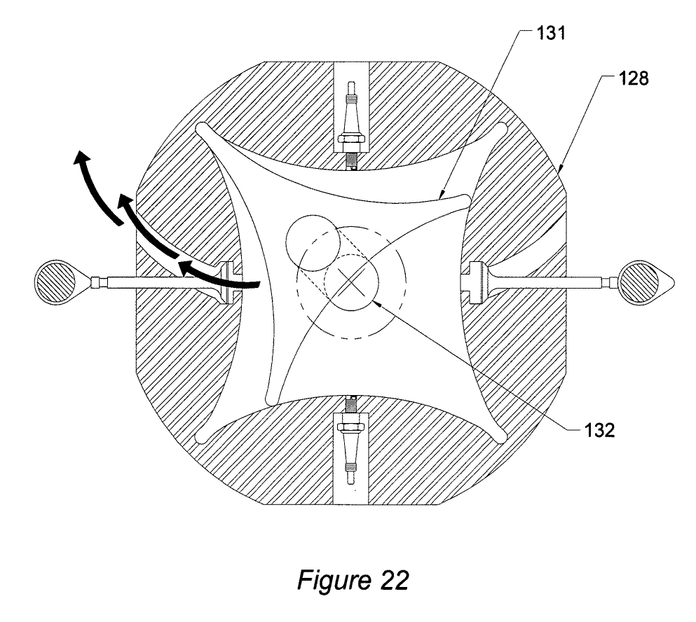

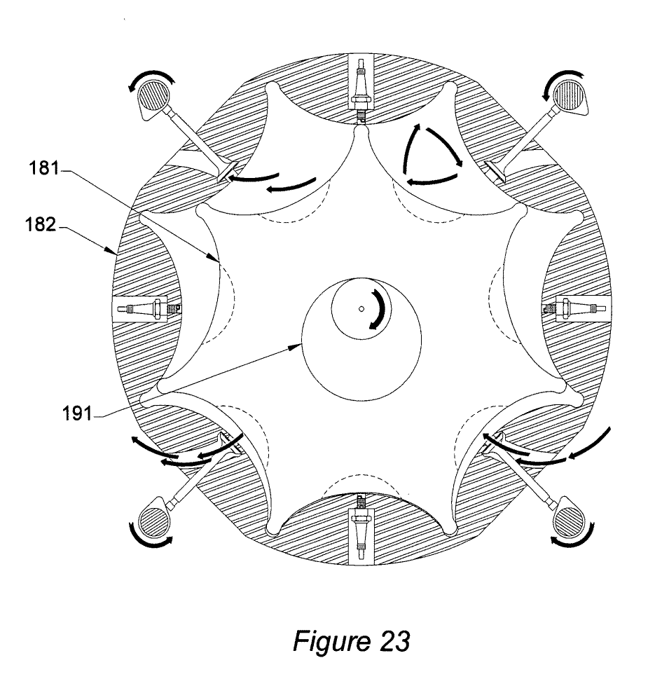

PART 2: The Application
1. Depending on the sizes between the two circles, this ratio can vary, meaning the types of Star Engine may also vary:
   The ratio of 3:4 creates a Star Engine Type 431, which the rotor (131) is a three-pointed star and the stator (128) is a four-pointed star. This engine comes with two spark plugs and two sets of valve trains (FIG. 22).
   The ratio of 5:6 creates a Star Engine Type 651, which the rotor (11) is a five-pointed star and the stator (1) is a six-pointed star. This engine comes with three spark plugs and three sets of valve trains (FIG. 3).
   The ratio of 7:8 creates a Star Engine Type 871, which the rotor (181) is a seven-pointed star and the stator (182) is an eight-pointed star. This engine comes with four spark plugs and four sets of valve trains (FIG. 23).

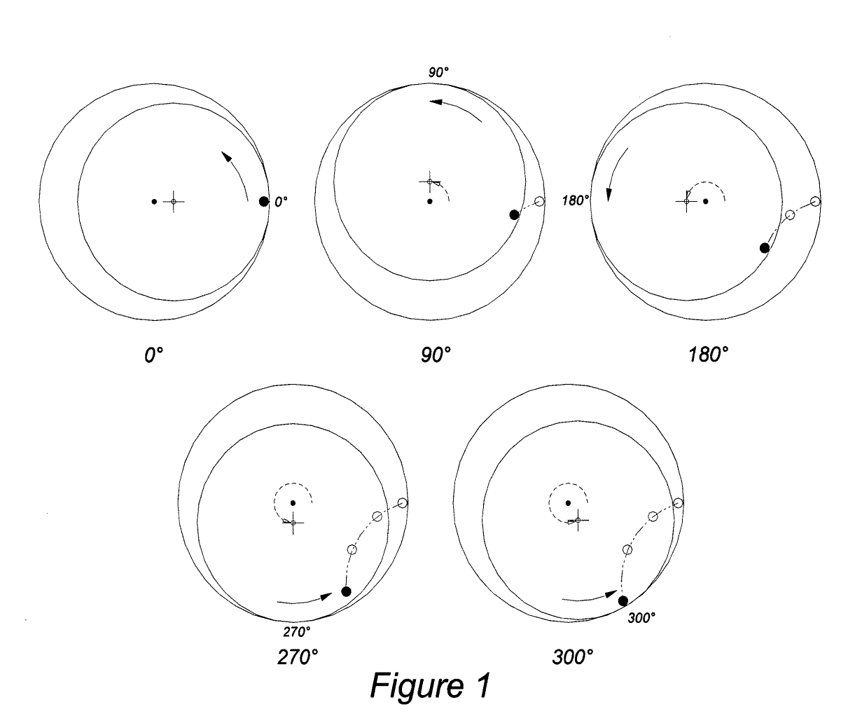

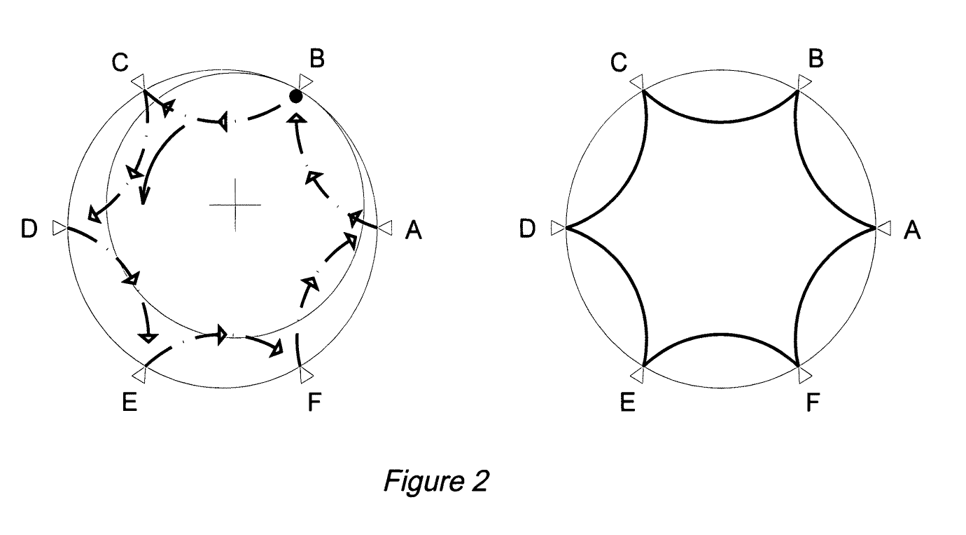

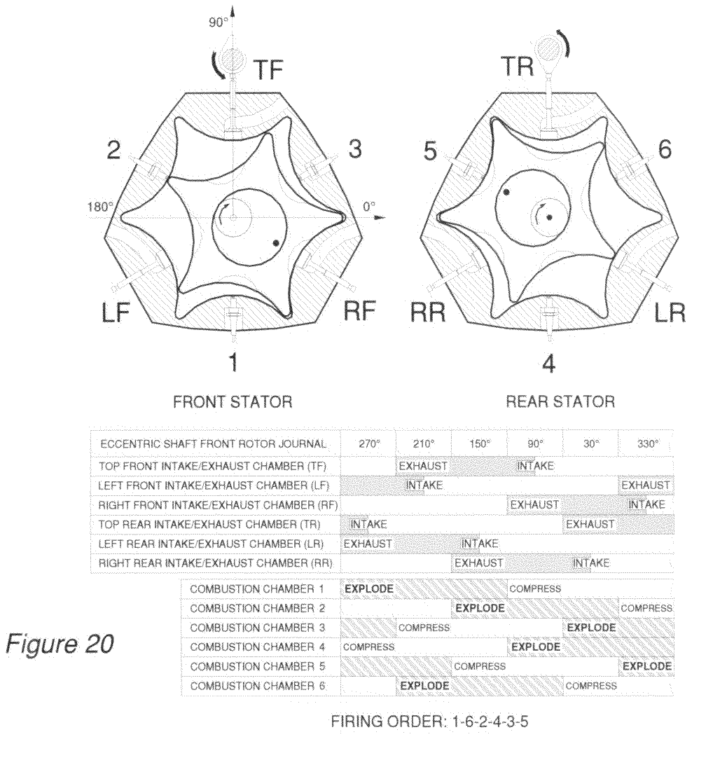

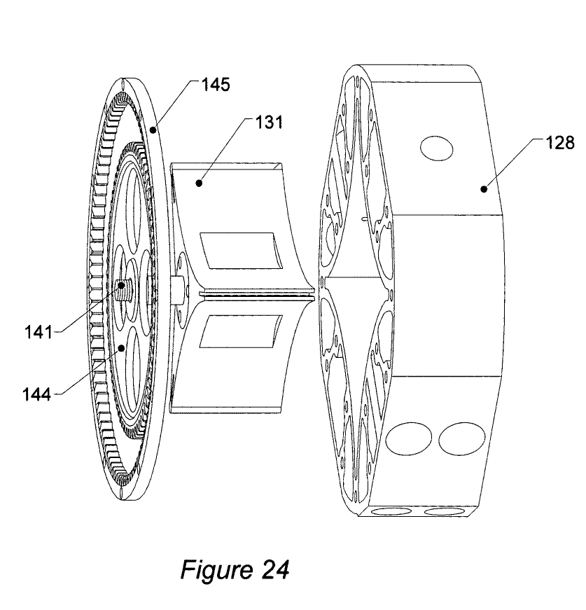

The first digit is the size of the large circle, or the stator. The second digit is the size of the small circle, or the rotor. The third digit, 1, is the difference between the large and small circle, or the diameter of the eccentric rotation of the eccentric shaft.
2. This ratio can be added up, and the small number is always the rotor
3. The number of rotors in an engine can vary, being single, double, triple, quadruple, etc
4. Star Engine is created by applying the principle of a small circle rolling inside a larger one (FIG. 1). Star Engine is built by taking advantage the eccentric turning of the small circle's center point, as well as the movement of a contacting point between the two circles moving in order from A, B, C, D, E, F, and coming back to A (FIG. 2), the increasing and decreasing of gaps between the rotor (small circle) rolling inside the stator (large one) (FIG. 3), the graphing and calculation of the engine operation (FIG. 20), and the ability to mathematically calculate the movement and journey of the small circle (FIG. 21).
5. The “True-Path” Star Engine is a kind of engine that applies an exact dimension and the principle of a small circle rolling inside a larger one. One side of the the rotor (131) is fixed on an inner gear (141) of the same size that turns eccentrically about a fixed outer gear (145) which is also the same size as the stator's rotor housing (128) (FIGS. 24 & 25). This “True-Path” could apply to any type of Star Engine.
6. Star Engine is a four stroke internal combustion engine, where fuel is burnt inside to produce power. The four stroke strokes are: intake, compress, power, and exhaust.

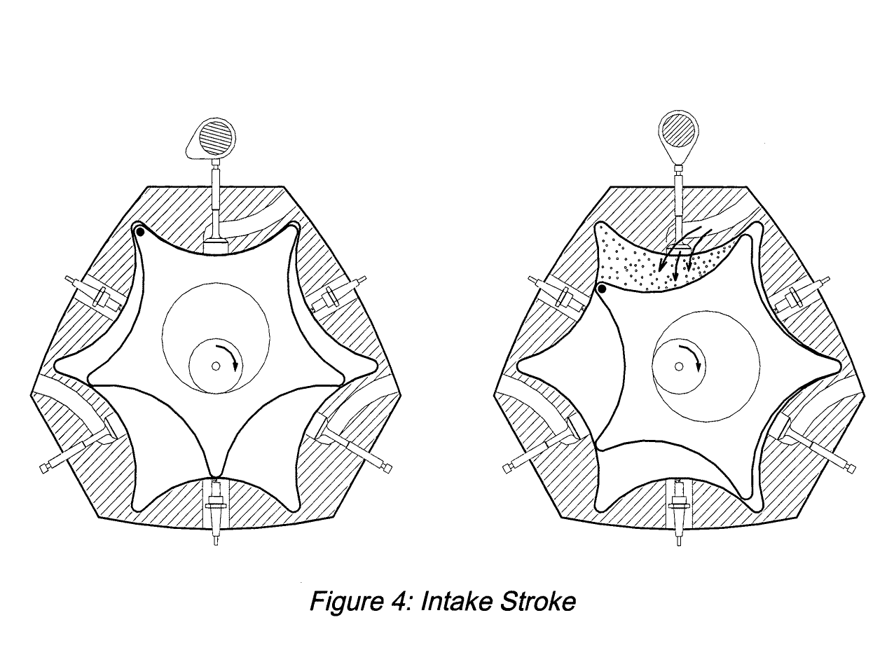

### Intake Stroke (FIG. 4)

The intake stroke starts when both the rotor and stator are completely closed (follow the dot on the end of the rotor). When the eccentric shaft starts to revolve clockwise, it forces the rotor to roll counter-clockwise and the gap between rotor and stator is open (or vice-versa). This situation forms low-pressure with a vacuum-like effect inside the combustion chamber. A mixture of fuel and air is then drawn into the combustion chamber when the intake valve opens.

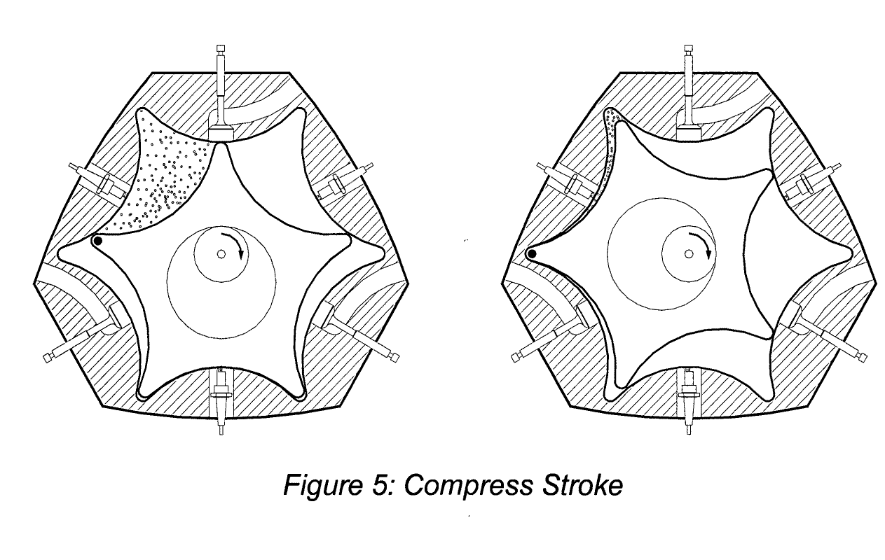

### Compression Stroke (FIG. 5)

Both the intake and exhaust valves are closed by the end of the intake stroke. This means that the mixture of fuel and air is “trapped” inside the combustion chamber. As the rotor continues to roll, the gap between the rotor and the stator is closed, and the mixture is compressed.

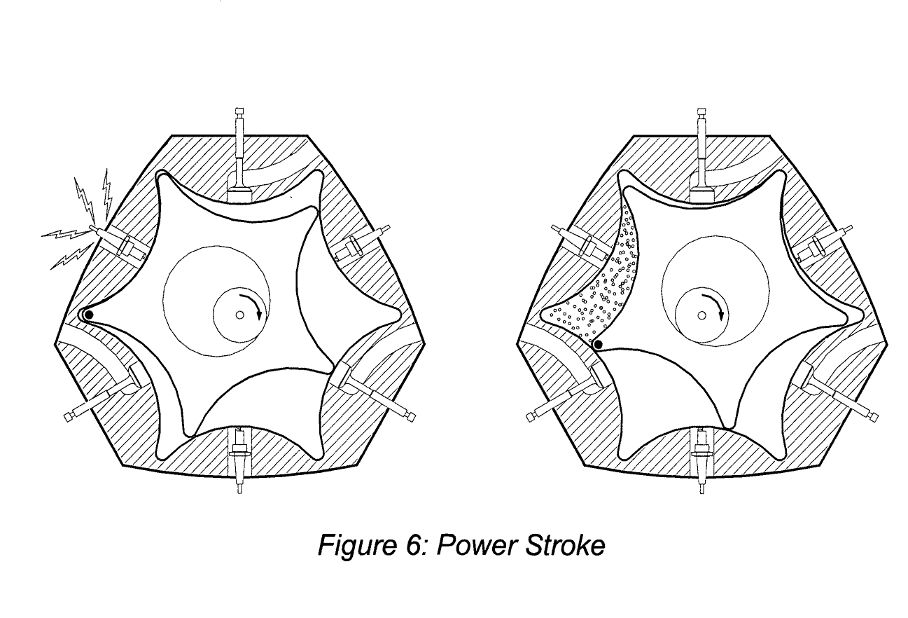

### Power Stroke (FIG. 6)

A spark is provided inside the combustion chamber near the end of the compression stroke, which causes the mixture of fuel and air to explode. This explosion forces the gap between rotor and stator to open again. The explosion stroke is the single source of power to manipulate the engine.

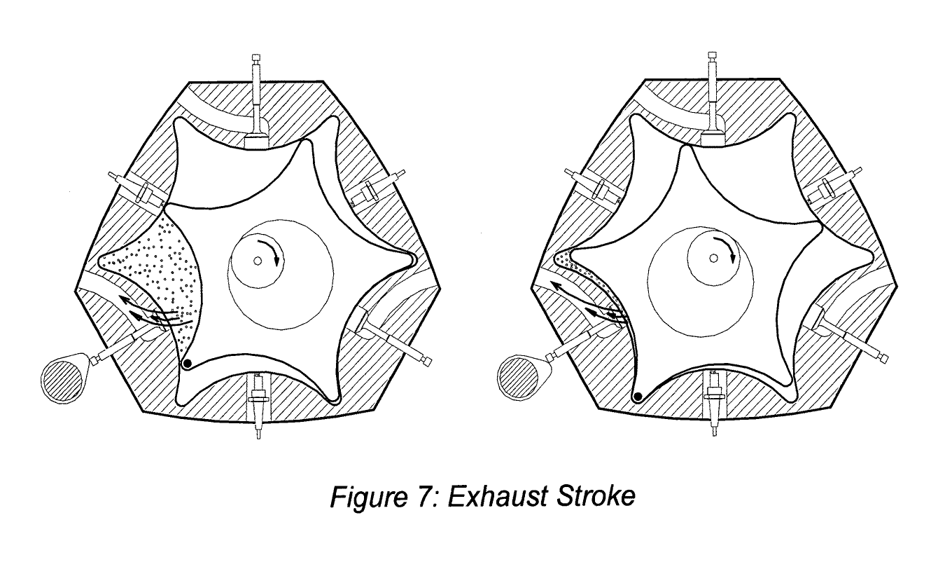

### Exhaust Stroke (FIG. 7)

After the mixture of fuel and air is ignited, combusted, and completely burned, it needs to be forced out and replaced with a fresh mixture for the next cycle. As the gap between the rotor and stator begins to close again, the exhaust valve opens and the burned gases are pushed out. A new cycle is then started.

### PART 3: The Embodiments of the Invention

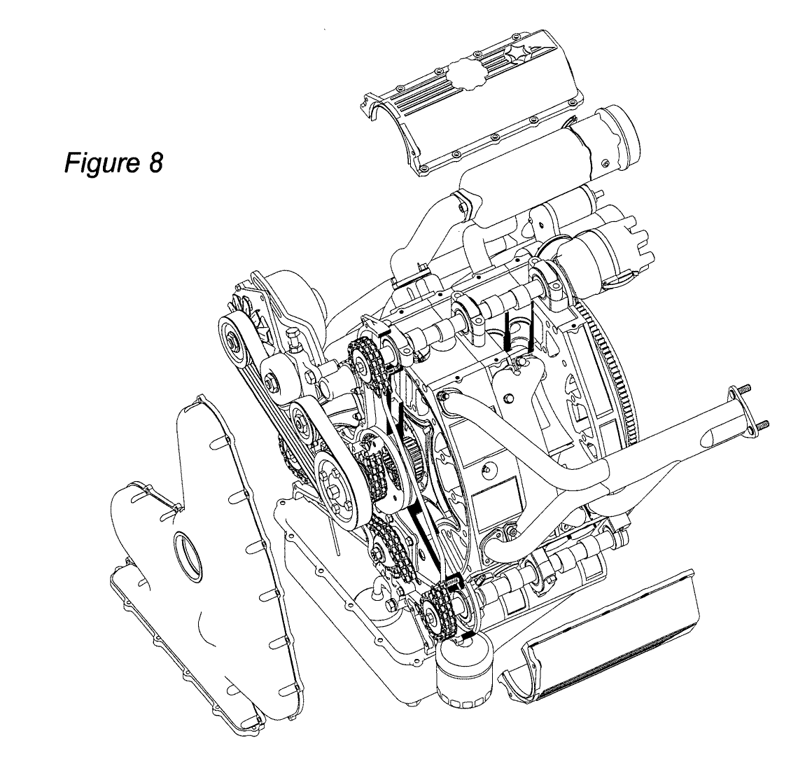

From the above opportunity, many variations of the engine may be built. A Star 651 water-cool with twin rotors in FIG. 8 is used as an example.

The large circle is cut along the path of the rotor to a six-pointed star called a stator, which is the housing for the rotor (1 & 5).The stator has a built-in rotor wall on the inner part of the stator (7) which is chrome-plated on the inner faces to prevent wearing. The stator is housing for three spark plugs and is divided into three complete valve train systems. (FIG. 3)

The water-cool stator is casted by a light but strong material such as aluminum, and is thin-walled (water pocketing) for the cooling liquid such as water to run through inside using a pump. The heated water then passes through a radiator (not shown) for cooling and reusing. The stator is grooved on both sides, and is sealed with a pair of outer and inner gaskets (8 & 9).

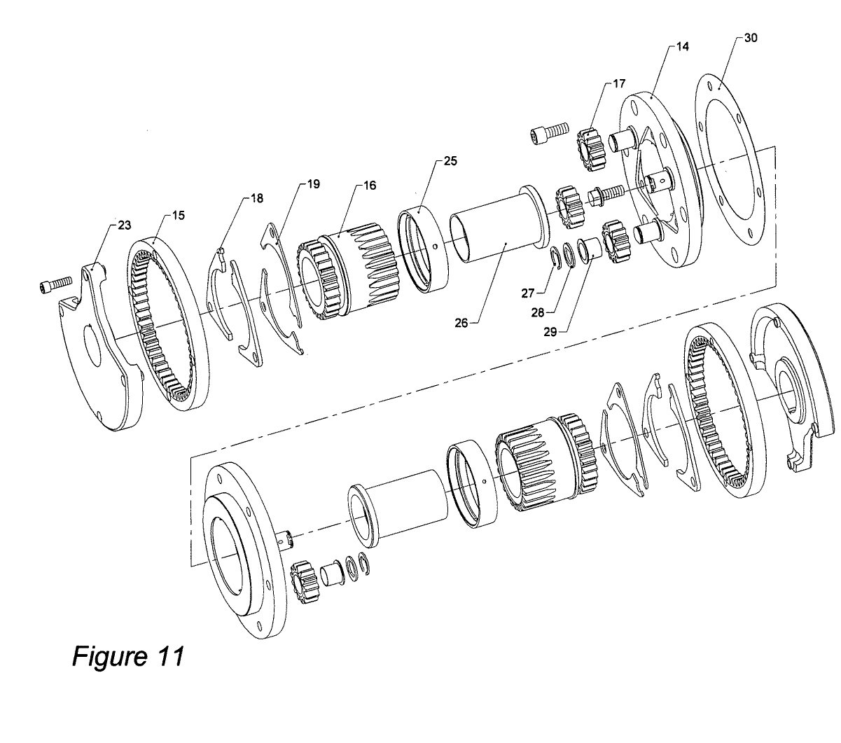

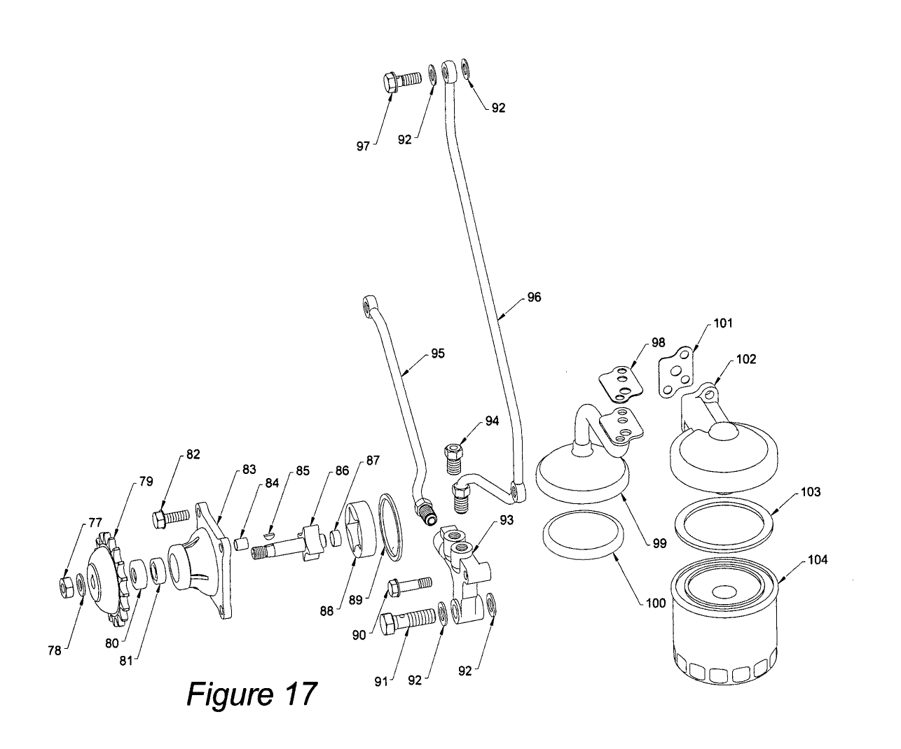

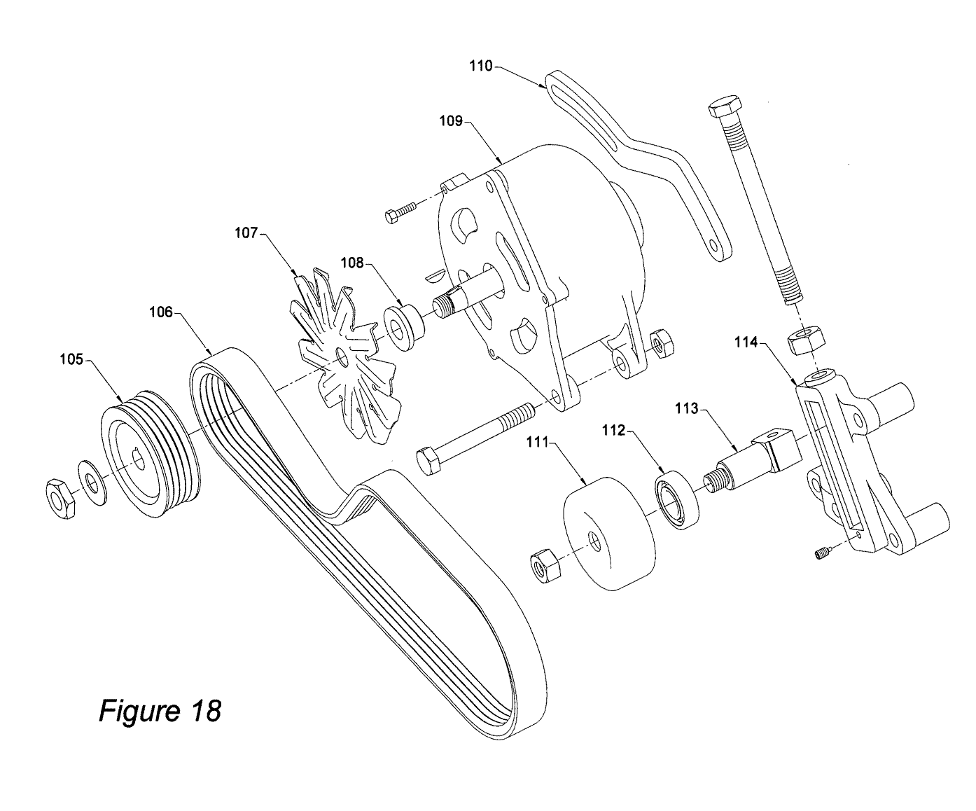

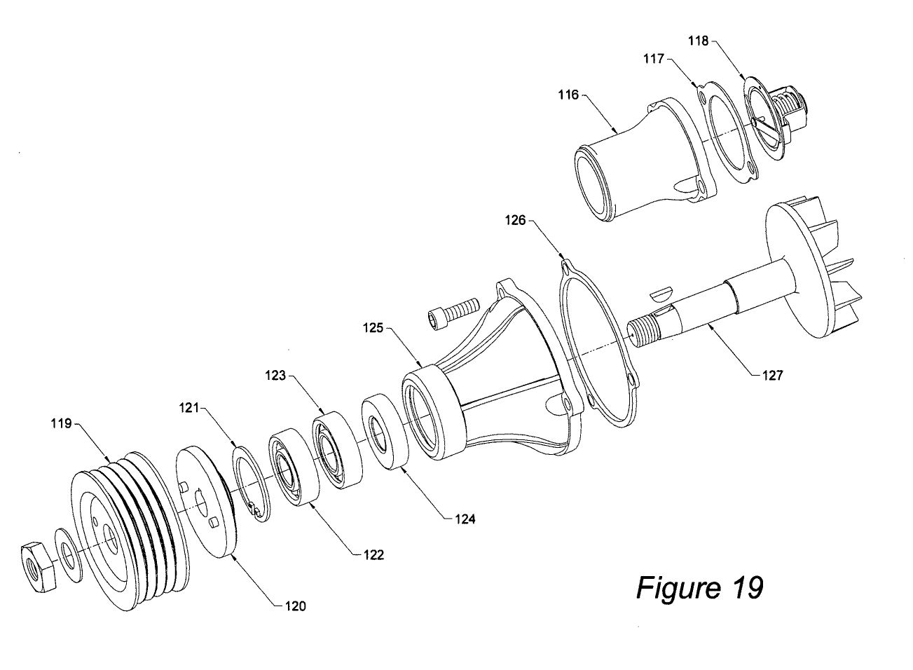

The rotor is housed on the front side by a front rotor cover (2). This part is cast-iron, which is heat-treated and hardened on side that houses the rotor. This part is water pocketed for cooling. This part also houses the planetary gearset (FIG. 11), the oil pump (FIG. 17), the alternator (FIG. 18), the thermostat, the water pump (FIG. 19)

In the middle of the front and the rear rotors is the intermediate rotor cover (4). In the top portion below the top camshaft holder is a built-in intake air tunnel that draws air from the air inlet on the left side to the right side of the engine. This part is thin-walled for cooling, and at the center of this part is a large through hole that houses the eccentric shaft. This part is heat-treated and hardened on both sides to house the front and rear rotors.

The rear end of the rear rotor is also housed by a rear rotor cover (6).This part is also thin-walled for water cooling. This part is cast-iron, and is also heat-treated and hardened on the side where it houses the rotor. In the center of the part there is a hole that houses for the planetary gearset.

The small circle in the shape of a five-pointed star called a rotor, which rolls inside its rotor housing (11a & 11b). The rotor has built-in combustion chambers hollowed on all of its curved sides (12). The rotor is grooved on the front and the back for sealing, and each peak is also grooved for apex seals (20 & 21). The rotor is the main part that generates power for the output.

The rotor turns the main shaft eccentrically to convert the eccentric turning of the rotor to a circular turning on the output. This output shaft is called the eccentric shaft (24) which is mounted with a planetary gearset in the central axis of the engine, which is also the center of the stator.

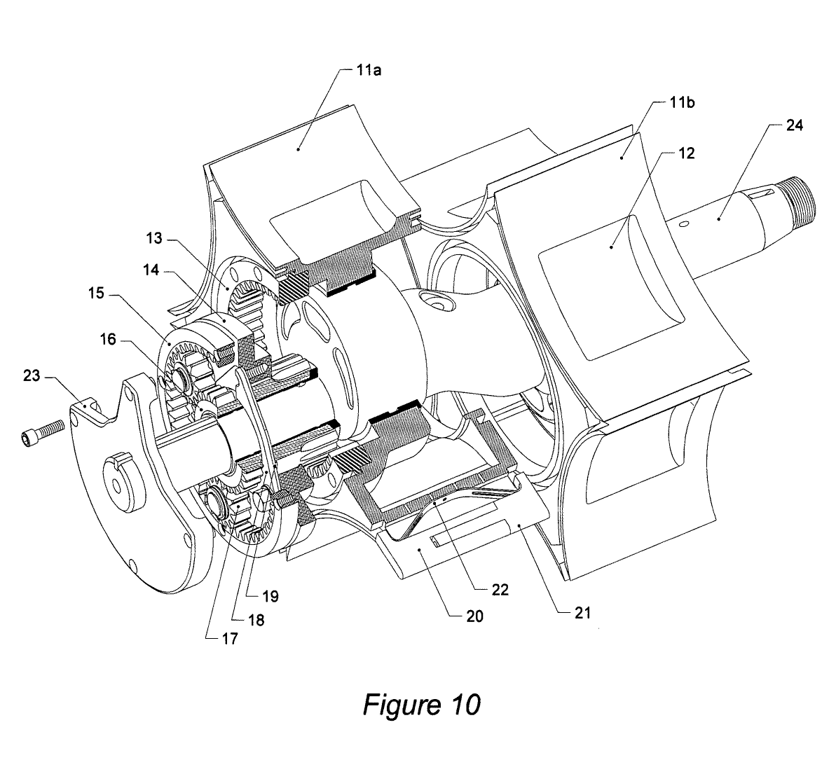

The planetary gearset (FIGS. 10 & 11) is used to convert the eccentric motion of the rotor to the rotary motion of the eccentric shaft, meshing the rotor to revolve on its own path without touching the rotor wall, setting the alignment of the rotor and eccentric shaft, and securing the main journals of the shaft. The planetary gearset comes with a ring gear (15) which is fixed to one end of the eccentric shaft using an eccentric shaft weight (24), which rotates the sun gear (16) in the opposite direction to the eccentric shaft over three neutral gears (17). The neutral gears are arranged and mounted on the planetary gearset housing (14) in equal spaces. The other end of the sun gear is meshed onto the rotor ring gear (13) which is fixed in the front of the rotor, forcing the rotor to roll in its own journey inside its housing.

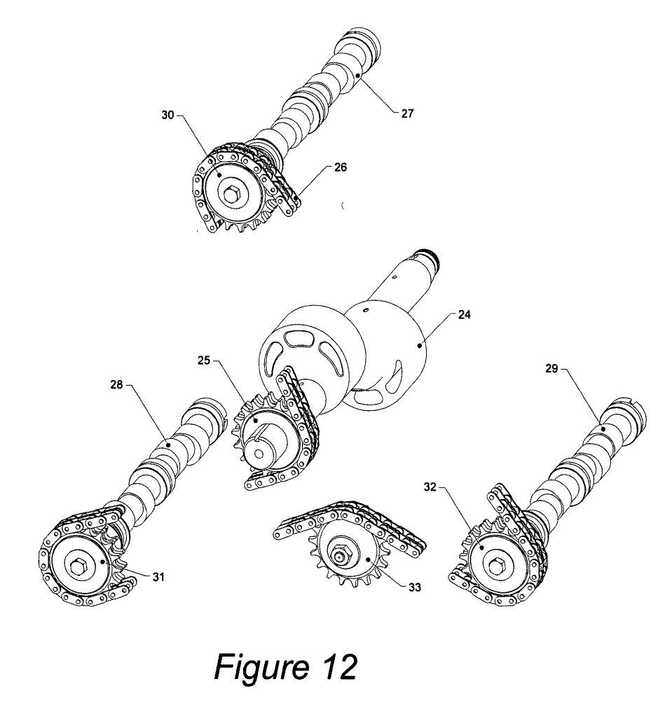

Star Engine 651 is equipped with three valve train systems (FIG. 12). The camshafts are arranged in even spaces: the top camshaft (27) mounted with the top camchain sprocket (30) on the front end, the left camshaft (28) with the left camchain sprocket (31), and the right camshaft (29) with the right camchain sprocket (32). All these sprockets and are linked to the eccentric shaft chain sprocket (25), which is then driven by the eccentric shaft using a timing chain (26). The chain is also linked to an oil pump sprocket (33) and a chain tensioner (not shown).

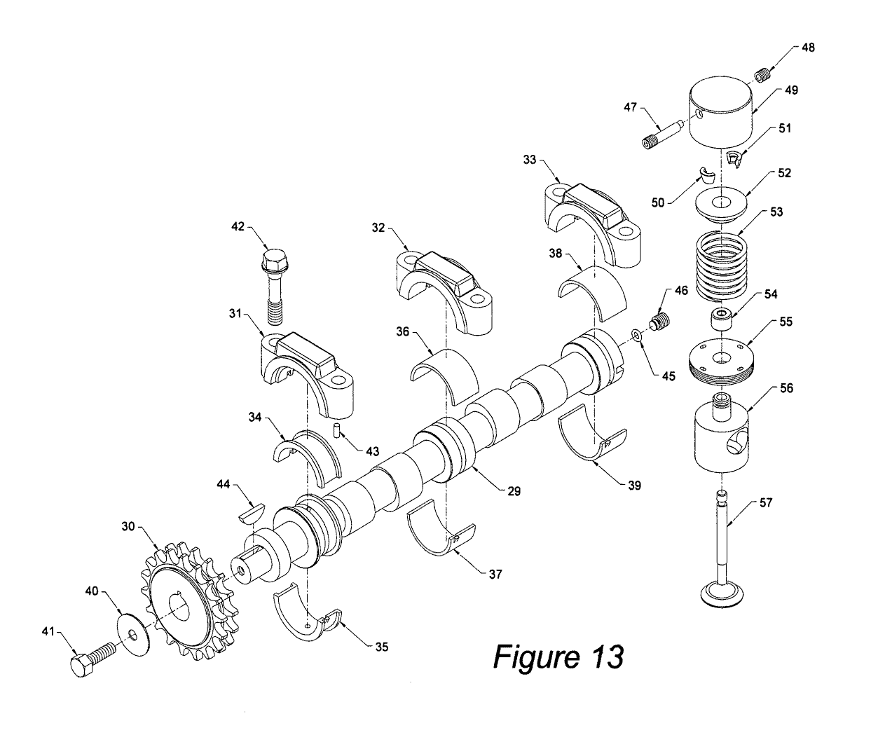

Each camshaft is mounted on the built-in camshaft holders of the front, the intermediate, and the rear rotor covers and fitted with two semi-circular bearings on its three main journals (FIG. 13): the front journal is fitted with the lower front bearing (35), upper front bearing (34) and secures the front camshaft holder (31). This pair of front bearings in the design are also used to secure the endplay of the camshaft. The intermediate journal is fitted with the middle upper bearing (36), the middle lower bearing (37), and secured with the middle camshaft holder (32). The rear journal is fitted with the rear upper bearing (38),the rear lower bearing (39), and secured with the rear camshaft holder (33).

Each intake and exhaust port is equipped with a removable valve train operated by a camshaft to open and closed the combustion chambers, letting the burnt gasses out and taking in a fresh mixture of fuel and air. The rotation of the camshaft converts its rotary motion to a reciprocating motion of the intake and exhaust valves (Also FIG. 13). As the camshaft turns, its lobe pushes the tappet (49) on top of a valve (57) up and down using a spring (53), retained by a spring retainer (52) and locked with a pair of valve keepers (51 & 52).This valve is housed by a valve housing (58) tightened with a valve housing retainer. The clearance of the valve stem can be adjusted with an eccentric valve adjusting screw (47) and locked with a cup screw (48).

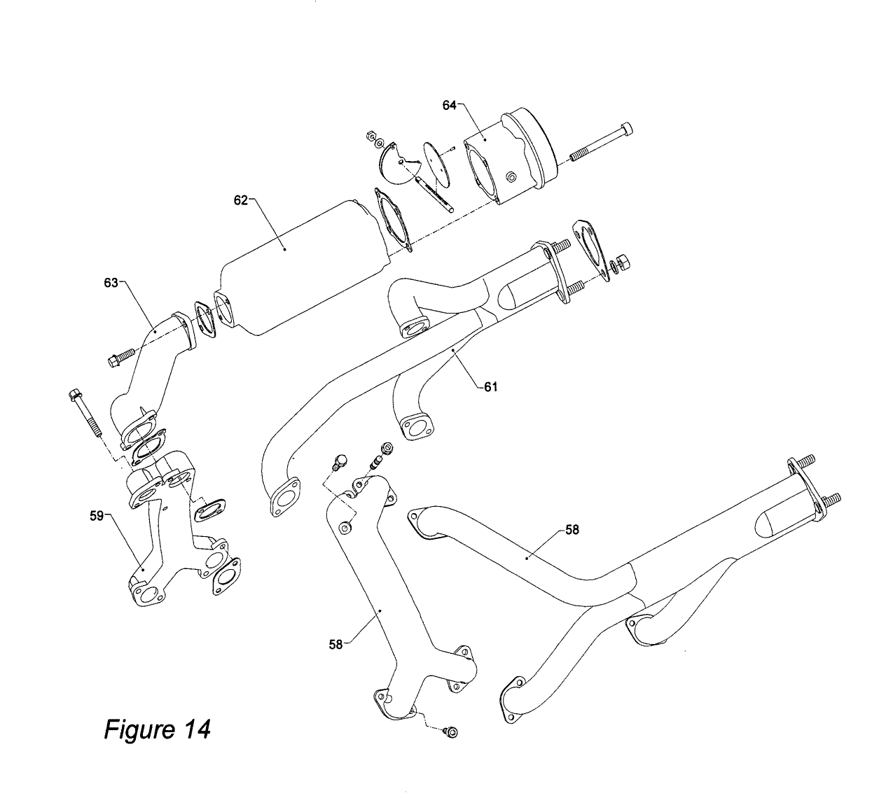

Before entering a combustion chamber, the air taken in must be free of impurities by going through an air filter (not shown). The amount of air is controlled by a throttle plate when going through the throttle body (58), intake manifold collector (62), inlet fitting (63), left intake manifold (59) and finally to the right intake manifold (58). The exhaust gases are blown out through the right exhaust manifold (61) and the left exhaust manifold (58) (FIG. 14).

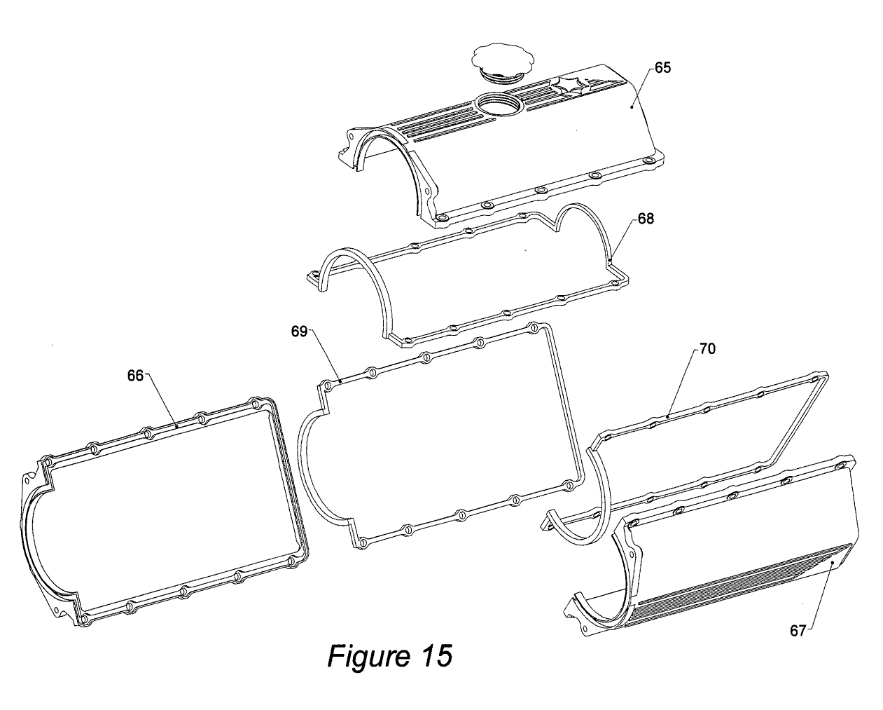

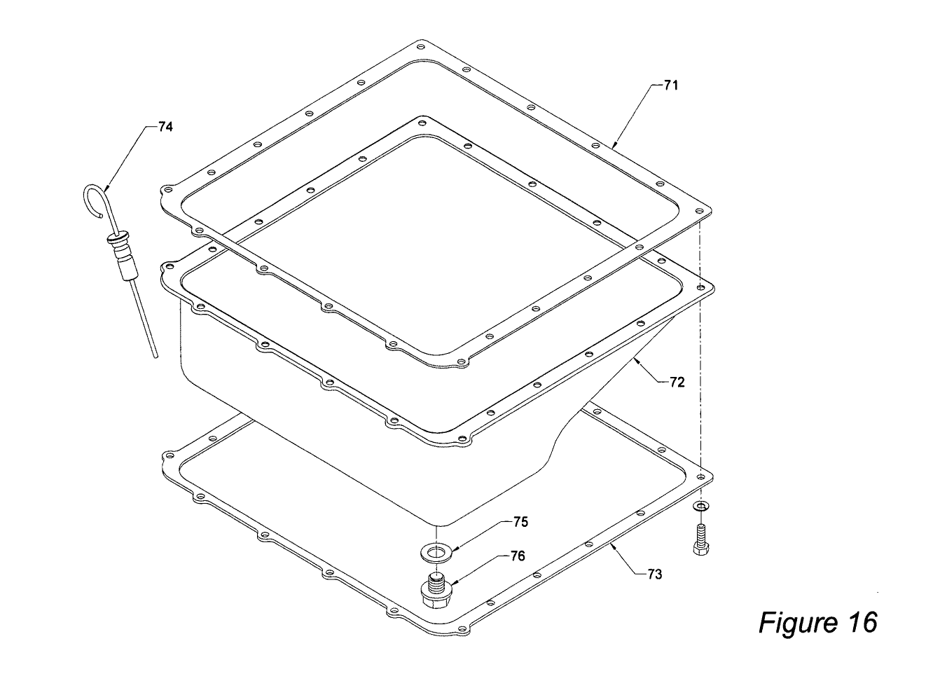

The valve train systems are covered with a top, left, and right valve cover (65, 66, & 67), which are sealed with gaskets (68, 69, & 70) (FIG. 15). The oil used for lubricating is the drained down to an oil pan (72) at the bottom of the engine which is sealed with and oil pan gasket (71) and supported by and oil pan supporter (73) (FIG. 16).

The lubrication system (FIG. 17) lubricates the engine with an oil pump driven by the eccentric shaft through the timing chain. The oil pump is of rotor type (77-89) mounted on the lower part under the planetary gearset housing of the front rotor cover. Oil is sucked through the oil screen (100) over the oil strainer (99) to the oil filter (104), which is then split by an oil branch (93). The oil then comes to the front planetary gearset, to the eccentric shaft through eccentric shaft oil passages, to the oil jet nozzles and finally to the rear planetary gearset. Oil also comes to the camshafts and their bearings through oil lines (95 & 96).

The electrical system (FIG. 18) comes with an alternator (109) mounted on the front rotor cover (2) and is driven the eccentric shaft (24) using a belt (106) and pulley (105). The belt tension can be adjusted by a belt tensioner (111), which is mounted on a tensioner bracket (114) and an adjustable tensioner bar (113) (FIG. 18).

The cooling system (FIG. 19) is used to maintain a normal, operational temperature for the engine to work in. There only some parts that attached to the engine are shown such as the water pump and the water outlet and their related components. The water pump is located above of the eccentric shaft and on the left front side of the front rotor cover. The water pump is driven by the eccentric shaft by a belt (106). The pump shaft (127) is centered inside the pump body (125) and mounted with the ball bearings (122 & 123) and sealed by a seal (124).

1. A twin rotor star engine comprising:
an eccentric shaft rotating about a central axis of the engine wherein its front main journal is mounted on a front rotor cover and its rear main journal is mounted on a rear rotor cover;
a pair of front and rear rotors driven eccentricly by the eccentric motion of the eccentric shaft;
a pair of front and rear stators housing for the front and rear rotor;
an intermediate rotor cover attached to the front and rear stator housing for the back of the front rotor and the back of the rear rotor;
a pair of balance weights attached to the front and the rear ends of the eccentric shaft balancing the rotation of the shaft;
a pair of planetary gearsets mounted to the front and rear rotor cover housing for the eccentric shaft front and rear main journals;
a pair of ring gears attached to the balance weights driving the planetary gearsets;
a pair of rotor ring gears attached to the front of the front rotor and the front of the rear rotor rotating the rotors eccentrically and driven by a pair of sun gears;
six sets of removable intake and exhaust valves, wherein each two sets of valves are driven by a camshaft mounted above them;
a set of three camchain sprockets attached on the front end of each camshaft and linked to a eccentric shaft chain sprocket with a chain;

2. The star engine of claim 1 wherein the stator has six rotor housing curved sides defined by the trigonometric equation r=cos θ+n cos α;

3. The star engine of claim 1 wherein the stator has three spark plug housings arranged at every 120 degree interval;

4. The star engine of claim 3 wherein the stator has three sets of intake and exhaust valve housings arranged at every two curved sides next to the spark plug housing;

5. The star engine of claim 1 wherein the stator has three sets of removable intake and exhaust valves inside.

6. The star engine of claim 1 wherein the rotor has five curved sides shaped by the trigonometric equation r=cos θ+n cos α;

7. The star engine of claim 1 wherein the rotor has five built-in combustion chambers hollowed on every curved side;

8. The star engine of claim 7 wherein the combustion chambers are located at the central part of each curved side;

9. The star engine of claim 1 wherein the rotor is grooved around the front and the back edges for sealing;

10. The star engine of claim 1 wherein the rotor is grooved on all peaks for sealing;

11. The star engine of claim 1 wherein the eccentric motion of the rotor can be determined and calculated by the trigonometric equation r=cos θ+n cos α;

12. The star engine of claim 1 wherein each set of planetary gearsets have a planetary gearset housing mounted on the central axis and houses a set of three neutral gears;

13. The star engine of claim 12 wherein the neutral gears are arranged in equal 120 degree intervals rotating the sun gear;

14. The star engine of claim 13 wherein the sungear is mounted on the central axis driving the rotor ring gear in an opposite direction to the eccentric shaft; and

15. The star engine of claim 14 wherein the sun gear is housed with a planetary gearset housing bearing and secured with a set of two side bearings and two side bearing retainers.
